(19) United States
(12) Patent Application Publication
(10) Pub. No.: US 2023/0419324 A1
(43) Pub. Date: Dec. 28, 2023

(54) AUTHENTICATING A CARD BASED ON CARD MOVEMENT

(71) Applicant: Capital One Services, LLC, McLean, VA (US)

(72) Inventors: Cruz Vargas, Ocean Springs, MS (US); Max Miracolo, Brooklyn, NY (US); Viraj Chaudhary, Katy, TX (US)

(21) Appl. No.: 17/847,771

(22) Filed: Jun. 23, 2022

(51) Int. Cl. G06Q 20/40; G06Q 20/34; G06F 21/31; G06F 21/34; G06N 20/00

(52) U.S. Cl. CPC G06Q 20/4014; G06Q 20/352; G06F 21/316; G06F 21/34; G06N 20/00

(57) ABSTRACT

Disclosed embodiments concern user authentication and detecting fraud at a card reader before an unauthorized transaction occurs based on card movement. A sensor can capture the movement of a card within proximity of a card reader that captures financial data from a card issued to a user. Card movement can correspond to the card's speed, acceleration, or motion during physical presentation of the card to the card reader. Card movement data associated with the card movement can be captured and compared to pre-stored data associated with an owner of the card to create a comparison result. A card user can be authenticated when the comparison result satisfies a predetermined threshold. Authorization of a transaction can then be performed based on an authenticated identity of the card user.

### BACKGROUND

The development of retail electronic commerce has been hampered by the failure to completely prevent card fraud, such as a user presenting and using a card that is not theirs. This potential for fraud has been a major concern for credit card companies, financial institutions, customers, and providers of goods and services.

Credit card companies have implemented fraud prevention features but have not eliminated all card fraud. One fraud prevention technique used in face-to-face transactions, card-present transactions, is checking signatures. Where the credit card is physically presented to a merchant, that merchant can obtain the credit card number and compare signatures before accepting a particular credit card.

There are also particular personal concerns for the consumer in that the fraudulent use of the credit card number may not become apparent for some time. This can happen even if the card is still in the authenticated cardholder's possession. Further, when fraud does occur, the consumer may have the task of persuading the credit card provider that fraud was caused by a bad actor.

There is also the additional fear of being overcharged on a credit card. There are thus particular risks for those credit cardholders with relatively high spending limits in that if fraud should occur, it may be a considerable time before the fraud is detected. One particular form of fraud, referred to as “skimming,” is particularly difficult to control. Skimming occurs when the cardholder proffers their card at an establishment to make a transaction, the relevant information is electronically or physically copied from the card, and the card is subsequently reproduced. This can be a problem for travelers, particularly during an extended period of travel, as the fraudulent card can turn up in other places, and it may be some considerable time before the fraud is detected.

Certain current approaches to limiting credit card fraud rely on the theft of a card being reported and elaborate verification systems, whereby altered patterns of use initiate some inquiry from the credit card company. Many authenticated credit cardholders receive telephone calls or even have their legitimate use of a card suspended when their use of the card has been exceptional or otherwise unusual in the eyes of the organization that provides the verification services. In cases of proper card use, these interruptions can be invasive, embarrassing, and quite frustrating to cardholders.

### SUMMARY

The following presents a simplified summary to provide a basic understanding of some aspects of the disclosed subject matter. This summary is not an extensive overview. It is not intended to identify key/critical elements or delineate the scope of the claimed subject matter. Its sole purpose is to present some concepts in a simplified form as a prelude to the more detailed description presented later.

Briefly described, embodiments of the subject disclosure can include a method for authenticating a cardholder and detecting fraudulent use of a card with a card reader based on card movement. The method senses card movement associated with a motion of a card moving within a proximity of a card reader device. The card is employed in a financial transaction. Card movement data associated with the card movement can be captured and compared to pre-stored data associated with an owner of the card to create a comparison result. A card user can be authenticated when the comparison result satisfies a predetermined threshold.

In another configuration, the method further includes sensing whether the card is physically touching the card reader device and factoring a physical contact of the card with the card reader device into the authentication. Fourier transforms can be used to determine whether the card movement data matches pre-stored data associated with the card owner. In another instance, the card movement data can be sensed using a sensor embedded within the card. Alternatively, the card movement data can be sensed using an accelerometer sensor embedded within the card.

In other aspects, the method can include other useful aspects and features. The method can detect the physical presence of the card at the card reader. A card present transaction flag can be set in the card movement data that represents the physical presence of the card at the card reader. The card present flag can be factored into user authentication and subsequent transaction authorization. In other instances, the card movement represents a back and forth waving motion of the card while the card is held by the owner of the card. Some configurations can determine whether the card movement data matches the pre-stored data using a machine learning model. In another aspect, the method can determine whether the card movement data matches the pre-stored data using edge computing on an internet-of-things (IoT) device. In other aspects, sensing the card movement data can be performed using a 9-axis sensor embedded within the card. Alternatively, the predetermined threshold for the comparison result can be based on a type, amount, or timing of the financial transaction.

In another aspect, embodiments can include a system that includes a card reader that captures financial account information from a card issued to a user. A sensor captures movement data associated with a card movement gait of the card in relation to the card reader. A correlator compares the card movement gait to a known card gait data unique to the user to create a comparison result. An authenticator validates the user based on the comparison result of the card movement gait with the known card gait data. The validation of the user allows a financial transaction associated with the card to proceed.

In another situation, a detection sensor establishes that the card is physically touching the card reader. The authenticator determines that the financial transaction is valid in response to physical contact with the card reader. The result is in response to a predetermined threshold of the comparison result related to an amount of the financial transaction. Another aspect includes a machine learning (ML) model to determine whether the card movement gait matches the known gait data. In another aspect, the correlator determines whether the card movement data matches the known gait data using edge computing on an internet-of-things (IoT) device.

Other embodiments can include a method executing, on an electronic device processor, instructions that cause the electronic device processor to perform operations for detecting fraudulent use of a card in a financial transaction. The operations include sensing card movement associated with a physical presentation of the card moving within a proximity of a card reader device. Card movement data is captured that represents the card movement. The card movement data is compared to pre-stored card movement data associated with an owner of the card to create a comparison result. A cardholder can be authenticated in response to the comparison result and a predetermined threshold.

In other features, the predetermined threshold is in response to a type, amount, or timing of the financial transaction. The method determines whether the card movement data matches the pre-stored card movement data using a machine learning model. In another aspect, the method determines whether the card movement data matches the pre-stored card movement data using edge computing on an internet-of-things (IoT) device. Also, the method can sense the card movement data using a sensor embedded within the card. The sensor can be an accelerometer, a 9-axis sensor, an inertial gyrometer sensor, or a magnetometer sensor.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

The accompanying drawings, which are incorporated in and constitute a part of the specification, illustrate various example methods and other example configurations of various aspects of the claimed subject matter. It will be appreciated that the illustrated element boundaries (e.g., boxes, groups of boxes, or other shapes) in the figures represent one example of the boundaries. It is appreciated that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an overview of an example implementation.

FIG. 2 is a block diagram of an authentication system.

FIG. 3 is a block diagram of another example authentication system.

FIG. 4 is a block diagram of a cloud computing/network system.

FIG. 5 is a block diagram of the abstraction layers of the cloud computing/network system.

FIG. 6 is a block diagram of another example authentication system.

FIG. 7 is a block diagram of another example authentication system.

FIG. 8 is a block diagram of another example authentication system.

FIG. 9 is a flow chart diagram of an example authentication system.

FIG. 10 is a flow chart diagram of an example authentication method.

FIG. 11 is a flow chart diagram of another example authentication method.

FIG. 12 is a block diagram illustrating a suitable operating environment for aspects of the subject disclosure.

### DETAILED DESCRIPTION

To more efficiently pre-process business transactions using a card reader, movement data of the card is collected. For example, movement data can be collected as the card is inserted into and from a slot-type of a card reader, or the movement data can be collected when the card is swiped through a swipe type of card reader. How a user inserts and removes or swipes their card with respect to a slot card reader or a swipe card reader often indicates a card insertion/removal “gait” or swiping “gait” of the card with respect to the card reader. An insertion/removal “gait” or swiping “gait” where a “gait” of the user is somewhat analogous with a walking gait with the card movement gait being unique to the card user. This gait detected at the card reader can be compared to a database of user gaits to determine if the users' card swiping gait matches any known gait cardholders. Determining if the current card swipe gait matches a known card user's gait can be performed before a business transaction has been approved. The determination can be used to cancel a transaction before the transaction occurs. Detecting potential fraud before a transaction has occurred can prevent fraud before the fraud occurs.

In more detail, this solution seeks to provide another data point at the upstream card swipe time of a potential transaction in order to solve the ever-prevalent problem of card fraud rather than detecting fraud primarily based on a traditional post-transaction analysis. Physical sensors on the card can also be used to determine whether the card was physically swiped or inserted at the same time the transaction was attempted. Physical sensor data at the card reader and from the card includes but is not limited to data collected from accelerometers, gyroscopes, magnetometers, and other sensors. The physical sensor data is collected at the time of a swiping of the card.

Other transaction data can be generated, specifically a “card present” or “card not present” transaction flag that indicates whether the transaction was attempted in person or remotely, such as online at the time of a possible card swipe. The collected physical sensor data from the physical sensors on the card is used to determine if the card itself made a swiping or insert motion with respect to a card reader. Artifacts of a swipe can include details of the card motion with respect to the card reader itself. For example, when a card is used in a swipe type of card reader, the card can have a short acceleration followed by constant acceleration followed by another short deceleration. In the case of inserting the card into a card reader device, artifacts of a card insertion could contain a short acceleration cycle followed by a very rapid deceleration and spike from the card bottoming out in the terminal/card reader. This card acceleration data, or gait, is then matched to known valid card owner gaits. The matching/processing for this calculation can be performed on the card, on a mobile device connected to the card, or relayed to the transaction server via a connected device or card's internet connection. Based on this data, a determination is made as to whether the card was actually swiped or inserted into a card reading box when the transaction was attempted. This determination can also be used in combination with existing fraud prevention calculations to determine whether to approve or deny the transaction.

Details disclosed herein generally pertain to a way of detecting card fraud before the fraud occurs. One example method senses card movement associated with a speed of a card moving within a proximity of a card reader device. Sensors collected movement data during the card movement. A determination is made as to whether the card movement data matches pre-stored data associated with an owner of the card. A business transaction is determined as valid based on whether the card movement data matches the pre-stored data associated with the owner of the card. In some instances, an ML model can be used to make all or part of these determinations, and the ML model can reside on an edge of the Internet of Things (IoT). The business transaction is authenticated when the business transaction is valid.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

“Processor” and “Logic”, as used herein, includes but are not limited to hardware, firmware, software, and/or combinations of each to perform a function(s) or an action(s), and/or to cause a function or action from another logic, method, and/or system. For example, based on a desired application or need, logic and/or processor can include a software-controlled microprocessor, discrete logic, an application specific integrated circuit (ASIC), a programmed logic device, a memory device containing instructions, or the like. Logic or processor can include one or more physical gates, combinations of gates, or other circuit components. Logic or a processor can also be fully embodied as software. Where multiple logics or processors are described, it may be possible to incorporate the multiple logics or processors into one physical logic (or processor). Similarly, where a single logic or processor is described, it may be possible to distribute that single logic or processor between multiple physical logics or processors.

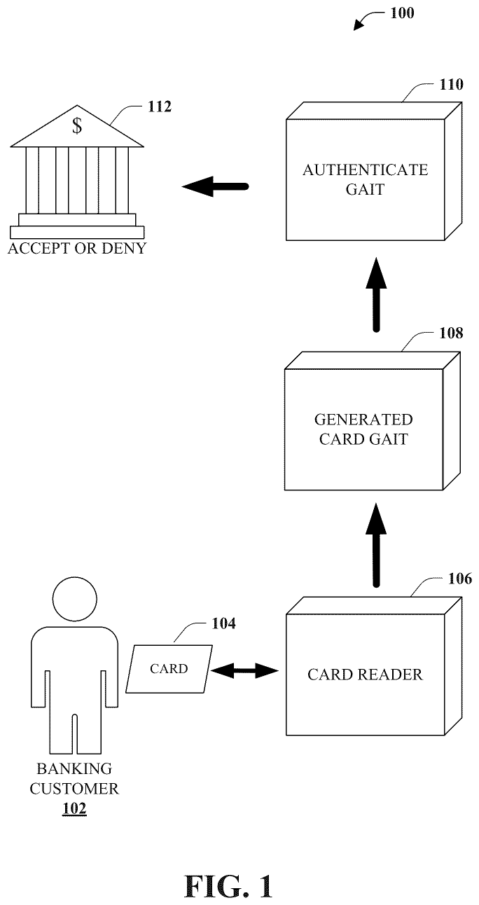

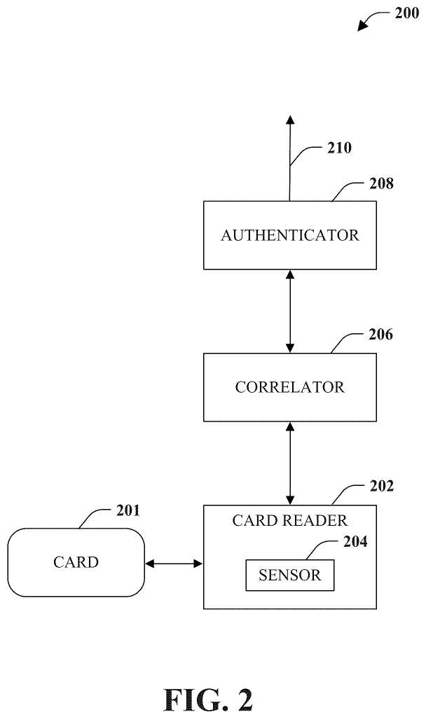

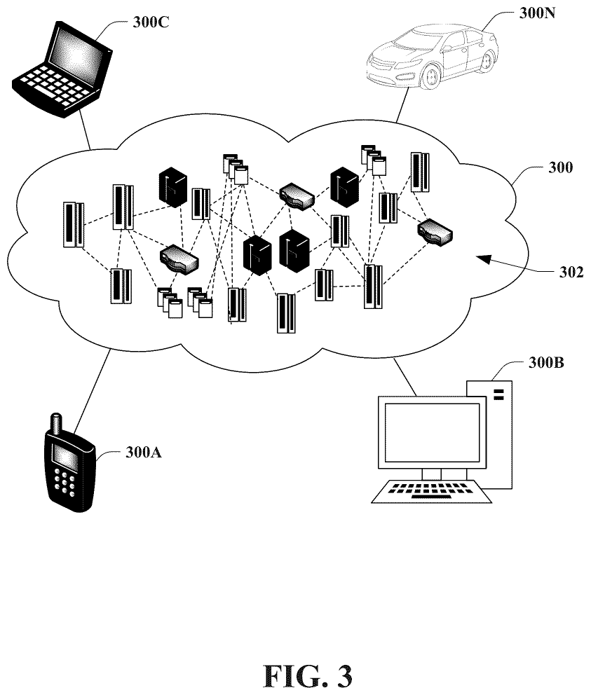

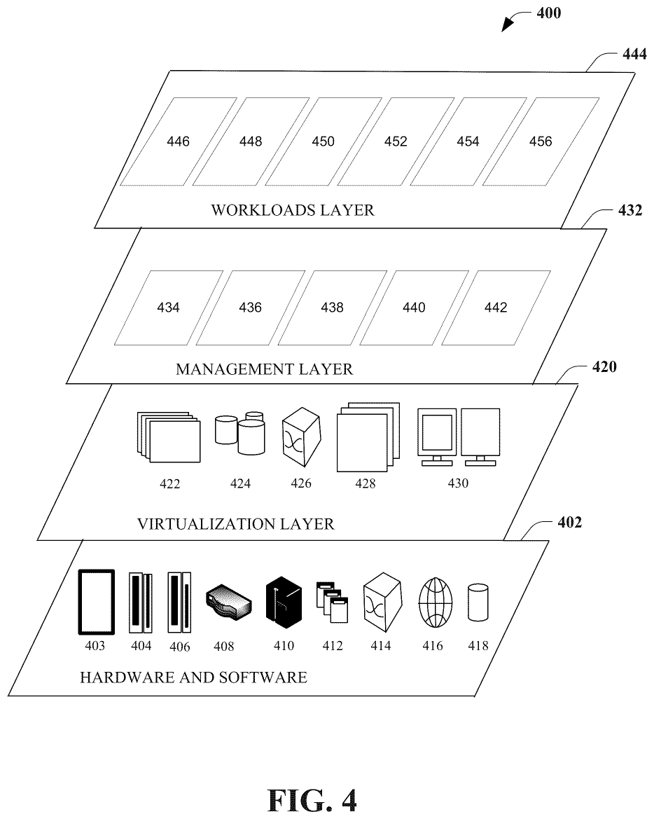

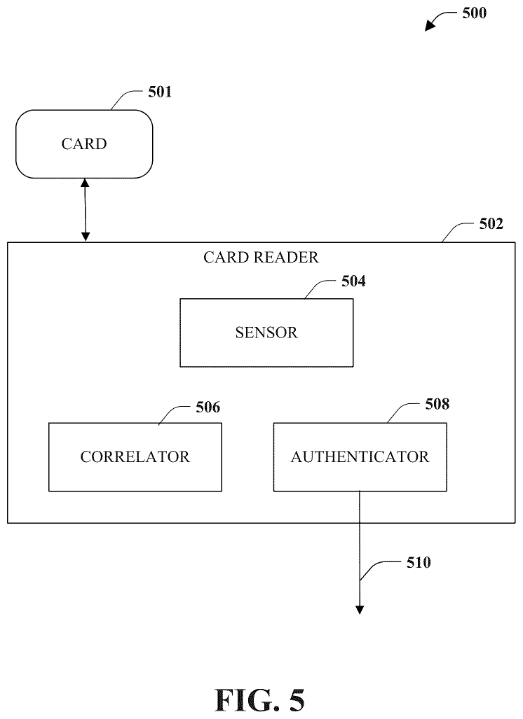

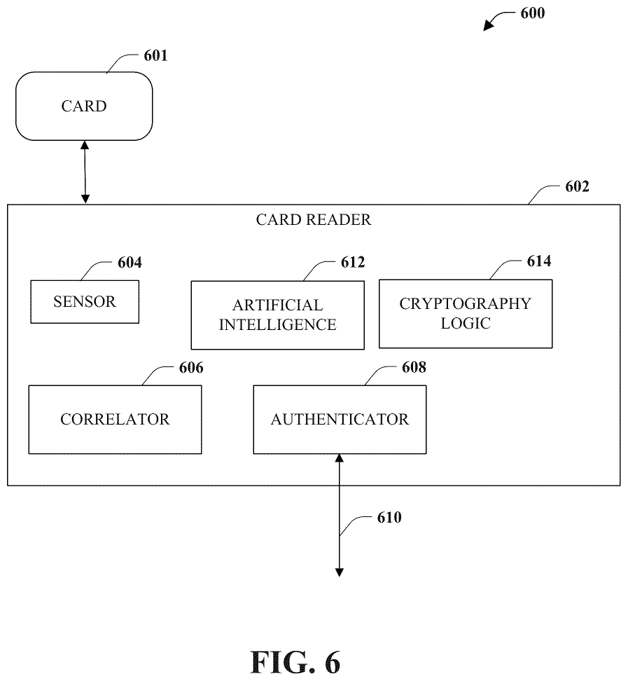

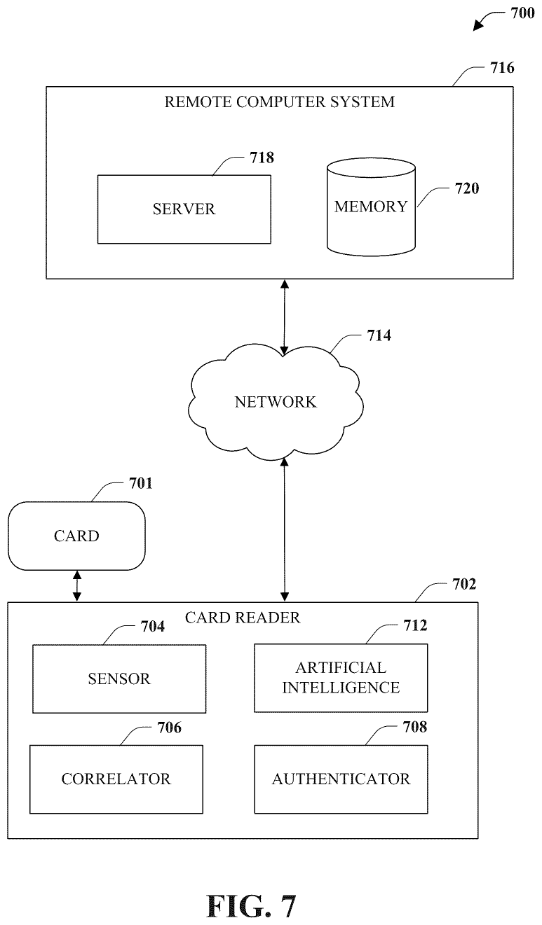

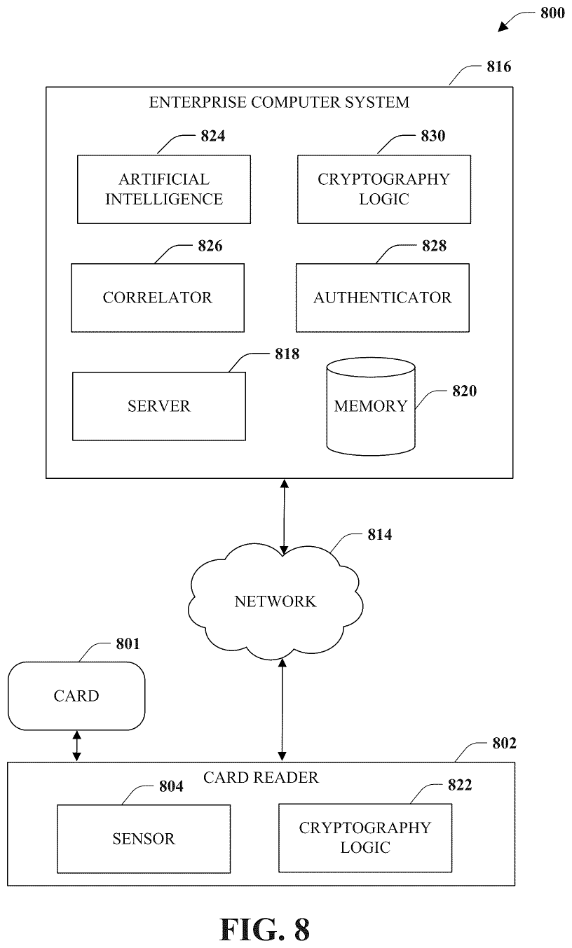

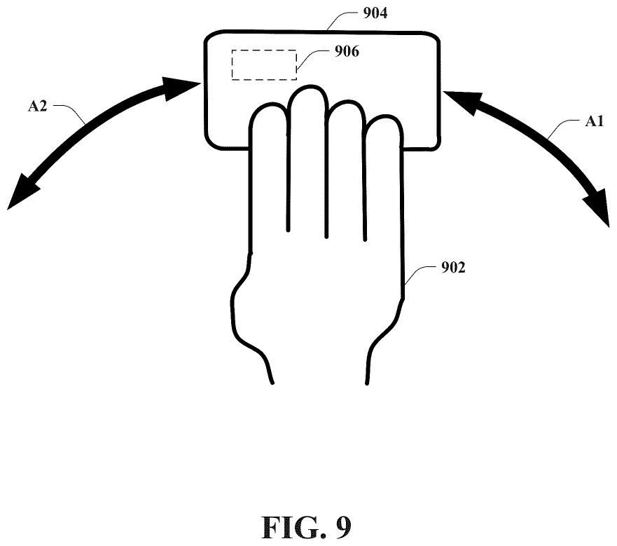

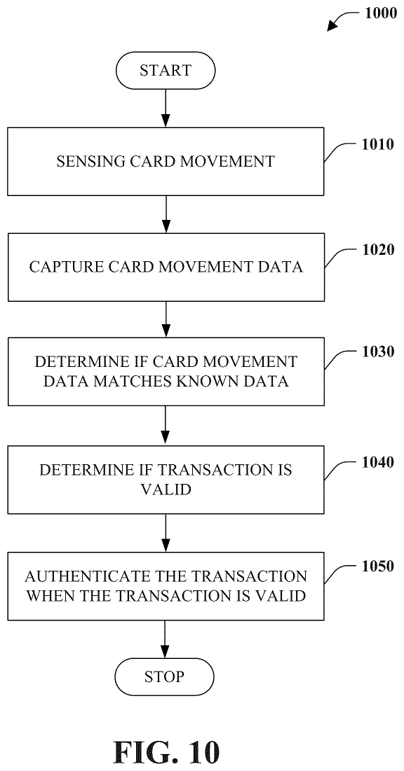

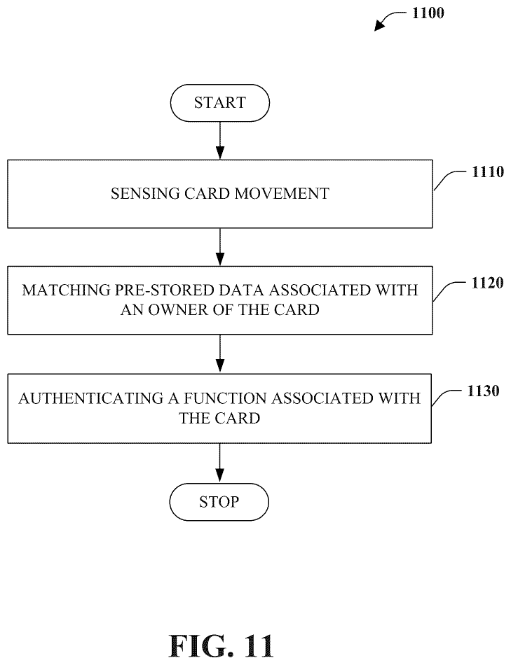

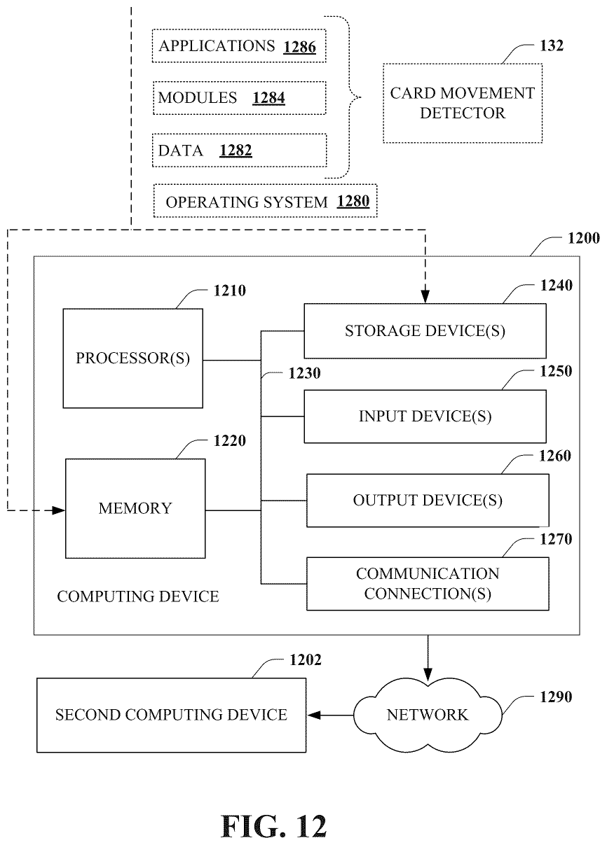

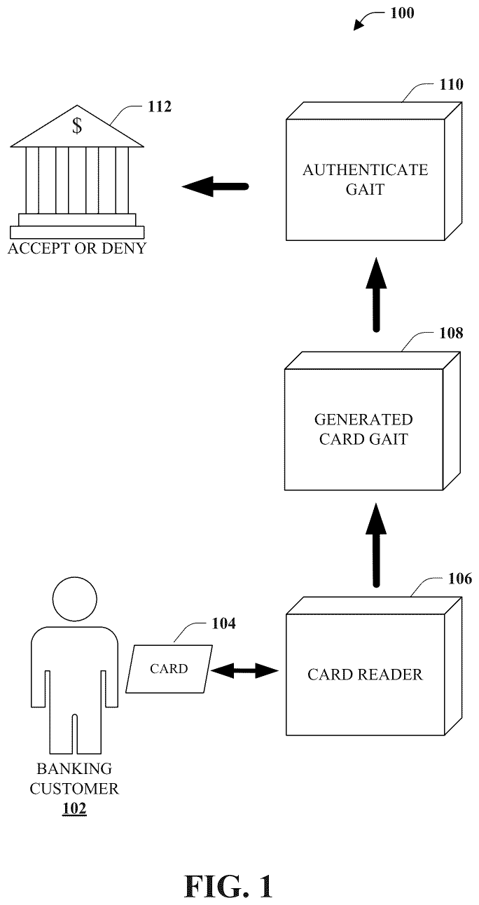

Referring initially to FIG. 1, a high-level overview of an example implementation of an environment 100 for detecting fraud in a transaction, potentially before the fraud occurs, is illustrated. The transaction can include a business transaction such as a banking transaction. Alternatively, the transaction (or function) can be the opening of a lock to provide access to a space for an owner of the card. For example, those transactions can occur at an automatic teller machine, in a retail setting using a card reader, at a department store using a card reader, at another business detecting the waving of a business card, and the like.

This business transaction is illustrated as an example banking transaction between a banking customer 102 and a bank 112. The banking customer 102 begins the transaction by presenting their card 104 to a card reader 106. The card reader 106 can be a swipe type of card reader, a slot type of card reader, or a “tap” type of card reader. Next, a gait of the card swipe is generated 108. For example, a sensor on the card, card reader, or both can collect data as the card 104 passes by the reader. The sensor can collect acceleration data to capture/generate an electronic format of a gait of the card swipe that can be unique to that banking customer 102. Once the gait has been generated, the gait is authenticated 110. In other words, a card user's identity can be authenticated based on the gait. For example, the gait can be correlated to the gaits of known banking customers.

As card movement data (e.g., a card movement gait) is collected, the new card movement data can be correlated/compared to different prior stored versions of pre-stored gait data that have been collected in the past for multiple card holders. If there is a match, then the bank 112 can allow the transaction the proceed or perform additional authentication or authorization. If there is no match, the transaction can be canceled. Checking card swipe gaits can pre-emptively prevent fraudulent transactions before those transactions are completed. Alternatively, the card can provide secure access to a space. Access to that space can be prevented if the gait data is not matched or the gait data matches a different user than the card owner.

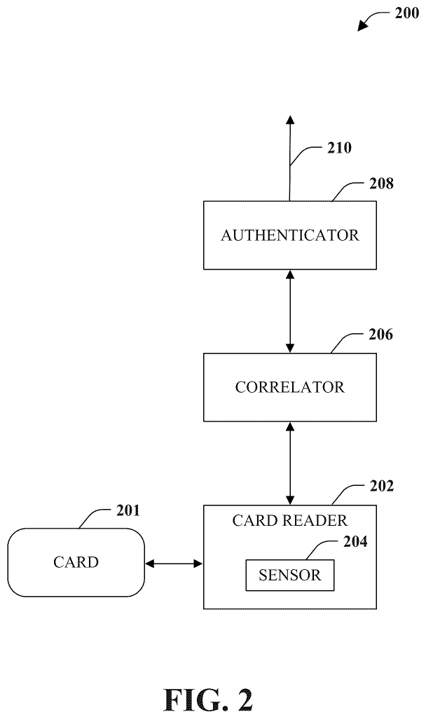

Turning attention to FIG. 2, a high-level overview of an example implementation of a system 200 for detecting fraud in a transaction before the fraud occurs is illustrated. The transaction can include business transactions such as a banking transaction. For example, those transactions can occur at an automatic teller machine, in a retail setting using a card reader, at a department store using a card reader, at another business location by detecting a waving motion of a business card, and the like. The transaction could also be waving or swiping a card at a device to gain access to a secured area.

This example implementation includes a card reader 202, a sensor 204, a correlator 206, and an authenticator 208. The card reader 202 can be a slot type of card reader or a swipe type of card reader. In general, the card reader 202 is a data input device that reads data from a card-shaped storage medium. Card readers can be electronic devices that can read plastic cards embedded with either a barcode, magnetic strip, computer chip, or another storage medium used to facilitate a business transaction, a banking transaction, or another transaction as understood by those of ordinary skill in the art.

The sensor 204 detects motion-related data with respect to a card 201 moving with respect to the card reader 202. The sensor 204 can be an accelerometer that measures the acceleration with respect to a stationary card reader. In some aspects, the sensor 204 captures movement data associated with the card's movement gait as the card 201 is moved with respect to the card reader 202. The movement gait of the card 201 can be relatively unique to the card owner in how the card owner moves the card 201 with respect to the card reader 202, similar to how a person has a relatively unique walking gait when they walk.

The correlator 206 is to correlate the card movement gait to a known gait data of the user. As, or after, card movement data (e.g., card movement gait) is collected, the correlator 206 compares this card movement data to different prior stored versions of pre-stored gait data that have been collected in the past for multiple card holders. The correlator 206 uses the results of these comparisons to determine if the card movement data matches any of those earlier stored versions of pre-stored gait data. If there is a match, then the business transaction can proceed, but if there is no match, the business transaction may not proceed and may be canceled. Alternatively, further testing may need to be performed to determine if the person presenting the card 201 is the actual owner of the card 201. Checking card swipe gaits in this way can pre-emptively prevent fraudulent transactions before those transactions are completed.

The correlator 206 can match the card movement data to different samples of pre-stored gait data in any way, as understood by those of ordinary skill in the art. For example, the correlator 206 can perform a Fourier transformation to convert the card movement data to the frequency domain because it can be much easier to make frequency domain comparisons between the card movement data and the pre-stored gait data. Alternatively, the correlator 206 can graphically compare the card movement data to the pre-stored gait data. A machine learning (ML) model could be used to compare the card 201 movement data to the pre-stored gait data. This can be performed in an edge ML model on the Internet of Things (IoT).

The authenticator 208 determines if the card movement data matches one of the prior stored versions of pre-stored gait data to an adequate level of confidence to conclude that prior card movement data matches one of the pre-stored gait data. In other words, the person swiping or inserting the card 201 across or into and out of the card reader 202 is an owner of the card 201 because their swipe or insertion/removal gait matches the gait of a known owner of the card 201. When the gait of the card movement has been verified to be a card owner, the authenticator 208 can determine a true card owner made the card movement. This result can be output on an output line 210 so that external devices and systems can act on the authentication. When the person swiping or inserting/removing the card 201 from a card reader 202 is verified, the business transaction can be permitted to proceed at the time of the sale or other transaction or function. If the person swiping or inserting/removing the card 201 from a card reader 202 is not verified and is determined to be fraudulent, the business transaction can be blocked/terminated as a fraudulent transaction.

In one example operation, the card reader 202 reads account information from a card 201 issued to a user. The card reader 202 will read this information by using one or more sensors 204 with the capability of reading magnetic data, memory cell data, or other data. As discussed above, a correlator 206 will correlate the card movement gait to a known gait data of the user. The correlator 206 can use Fourier transformation in the frequency domain data or correlate in another way. The authenticator 208 authenticates the card movement gait with the known gait data to authenticate the user. The authenticator 208 authenticates the user before the business transaction occurs with respect to the card 201 to prevent fraud before fraud occurs with respect to the business transaction. The authenticator 208 allows a business transaction associated with the card 201 to proceed when the card user is authenticated with the known gait data.

In another aspect, a detection sensor is adapted to determine whether the card 201 is physically touching the card reader 202. The authenticator 208 determines whether the business transaction is valid based on whether the card is physically touching the card reader. Thus, if the card movement data is matched to one of the different samples of pre-stored gait data and the card is physically touching the card reader, then the authenticator 208 can validate the transaction.

In other instances, a machine learning (ML) model (e.g., artificial intelligence) determines whether the card movement gait matches the known gait data. The correlator 206 determines this using edge computing on an internet-of-things (IoT). This can be performed in an edge ML model on the IoT. Periodically, the updated edge ML model can be sent from the edge IoT to a more central enterprise server, acting as a keeper of master versions of the pre-stored gait data and the ML model.

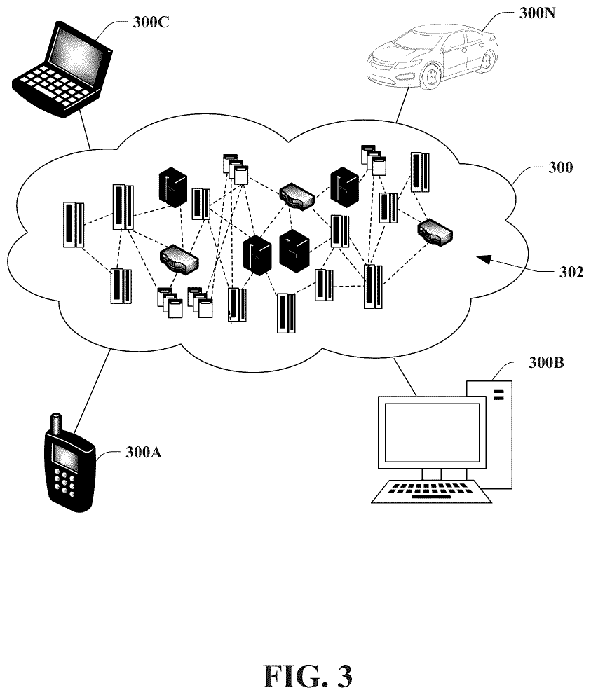

Referring now to FIG. 3, an illustrative cloud computing environment 300 of where the card reader 202 of FIG. 2 can reside is depicted. As shown, the illustrative cloud computing environment 300 comprises one or more distributed systems (e.g., cloud computing nodes) 302 with which local computing devices used by cloud consumers, such as, for example, a personal digital assistant (PDA) or a cellular telephone 300A, a desktop computer 300B, a laptop computer 300C, and/or an automobile computer system 300N can communicate. The cloud computing nodes 302 can communicate with one another. They can be grouped (not shown) physically or virtually in one or more networks, such as Private, Community, Public, or Hybrid clouds as described hereinabove, or a combination thereof. This allows the illustrative cloud computing environment 300 to offer infrastructure, platforms, or software as services for which a cloud consumer does not need to maintain resources on a local computing device. It is understood that the types of computing devices 300A-N shown in FIG. 3 are intended to be illustrative only, and that computing nodes and the illustrative cloud computing environment 300 can communicate with any type of computerized device over any type of network and/or network addressable connection (e.g., using a web browser).

Network edges are subnetworks positioned closer to end-users and can be directly connected to the network core. Examples of network edge devices include WiFi access points, branch offices with wiring closet switches, and individual computers. Edge network machinery facilitates caching, service discovery, storage, and device management to enhance user experience while reducing latency and bottlenecks.

Real-time performance can be increased using edge computing and one reason for using an edge-computing architecture. Edge computing can also help prevent overloading network backbones by processing more data locally and sending to the cloud only data that needs to go to the cloud. There could also be security, privacy, and data sovereignty advantages to keeping more data close to the source rather than shipping it to a centralized location.

In general, functions best handled by the computing split between the end device and local network resources will be done at the edge, while big data applications that benefit from aggregating data from everywhere and running it through analytics and machine learning algorithms running economically in hyper-scale data centers can stay in the cloud. It will be rare that an application will live only in edge computing if there is a need to communicate and interact with other workloads that are in the cloud or in an enterprise data center or on another device.

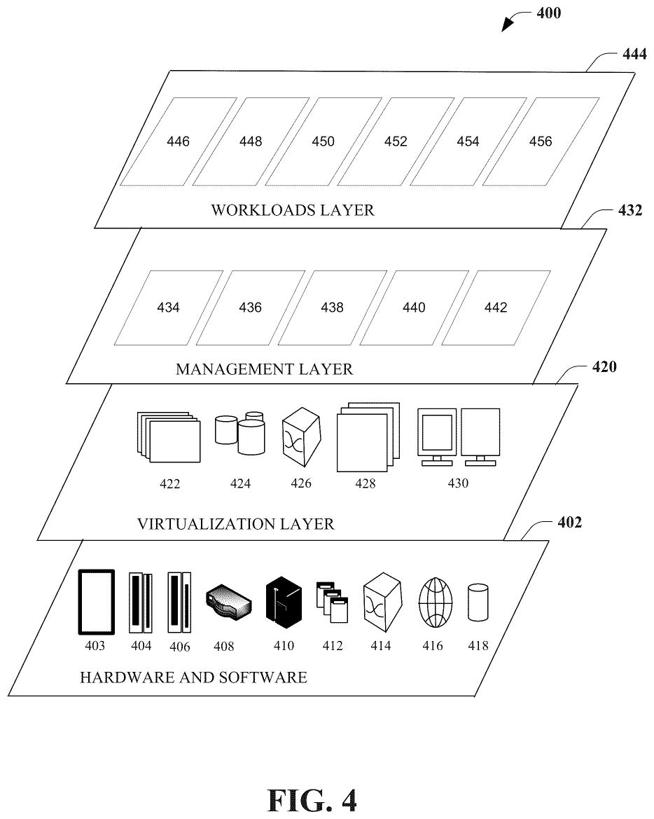

Referring now to FIG. 4, a set of functional abstraction layers 400 provided by the illustrative cloud computing environment 300 of FIG. 3 is shown. It should be understood in advance that the components, layers, and functions shown in FIG. 4 are intended to be illustrative only and embodiments of the illustration are not limited thereto.

As depicted, the following layers and corresponding functions are provided. Hardware and software layer 402 includes hardware and software components. Examples of hardware and software components include a card reading device that can include an ML model 403, mainframes 404, RISC (Reduced Instruction Set Computer) architecture based servers 406, servers 408, blade servers 410, storage devices 412, networks and networking components 414, and other devices. In some embodiments, software components include network application server software 416 and database software 418.

The virtualization layer 420 provides an abstraction layer from which the following examples of virtual entities can be provided: virtual servers 422; virtual storage 424; virtual networks 426, including virtual private networks; virtual applications and operating systems 428; and virtual clients 430.

In one example, the management layer 432 can provide the functions described below. Resource provisioning 434 provides dynamic procurement of computing resources and other resources that are utilized to perform tasks within the cloud computing environment. Metering and Pricing 436 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 438 provides access to the cloud computing environment for consumers and system administrators. Service level management 440 provides cloud computing resource allocation and management such that required service levels are met. Service Level Agreement (SLA) planning and fulfillment 442 provide pre-arrangement for, and procurement of, cloud computing resources for which a future requirement is anticipated in accordance with an SLA.

Workloads layer 444 provides examples of functionality for which the cloud computing environment can be utilized. Examples of workloads and functions which can be provided from this layer include mapping and navigation 446, software development and lifecycle management 448, virtual classroom education delivery 450, data analytics processing 452, transaction processing 454, and storage alteration monitoring 456. A data storage alteration monitoring program provides a way to control SA monitoring in a computer system that employs a physical main memory and memory paging to store and retrieve data from a secondary data storage for use in the physical main memory.

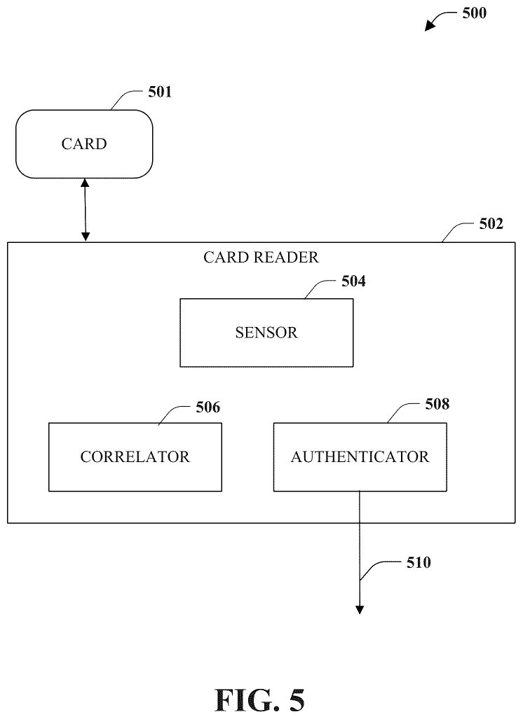

FIG. 5 illustrates another example system 500 for detecting the movement of a card to authenticate the card. The example system 500 validates usage of a card 501 with a card reader 502. Similar to FIG. 2, the example system 500 includes a sensor 504, a correlator 506, and an authenticator 508. In this example configuration, the correlator 506, and the authenticator 508 are illustrated as being part of the card reader 502 and can be implemented in hardware, silicon, or other materials. Alternatively, the correlator 506 and the authenticator 508 can be computer-executable components specified in terms of instructions that cause a processor to perform the functionality of each component.

The card reader 502 can be a slot type of card reader, a swipe type of card reader, or another type of card sensing device. In general, the card reader 502 is a data input device that reads data from a card-shaped storage medium. Card readers can be electronic devices that can read plastic cards embedded with either a barcode, magnetic strip, computer chip, or another storage medium used to facilitate a business transaction, a banking transaction, or another transaction as understood by those of ordinary skill in the art.

The sensor 504 detects motion-related data with respect to a card 501 moving with respect to the card reader 502. The sensor 504 can be an accelerometer that measures the acceleration with respect to a stationary card reader. The sensor can also be a 9-axis sensor, inertial motion sensor, a magnetometer, a gyroscope/gyrometer sensor, or another sensor. In some aspects, the sensor 504 captures movement data associated with the card's movement gait as the card 501 is moved with respect to the card reader. The movement gait of the card 501 can be relatively unique to the card owner in how they move the card 501 with respect to the card reader 502.

The correlator 506 correlates the card movement gait to a known gait data of the user. As card movement data (e.g., card movement gait) is collected, the correlator 506 compares this card movement data to different prior stored versions of pre-stored gait data that have been collected in the past for multiple card holders. The correlator 506 uses the results of these comparisons to determine if the card movement data can match any of those earlier stored versions of pre-stored gait data. In other instances, the correlator 506 can perform a Fourier transformation to convert the card movement data to the frequency domain because it can be much easier to make frequency domain comparisons between the card movement data and the pre-stored gait data that may likewise be stored as frequency domain data.

The authenticator 508 determines if the card movement data matches one of the prior stored versions of pre-stored gait data to an adequate confidence level to conclude that prior card movement data matches one of pre-stored gait data. This determination is output on line 510 so that this result can be transmitted to an entity that can allow the transaction or can block the transaction initiated at the card reader 502. When the gait of the card movement has been verified to be a card owner, the authenticator 508 can be determined to verify a true card owner created the card movement. When the person swiping or inserting/removing the card 501 from a card reader 502 is verified, the business transaction can be permitted to proceed at the time of the sale. If the person swiping or inserting/removing the card 501 at a card reader 502 is not verified and is determined to be fraudulent, the business transaction can be blocked/terminated as a fraudulent transaction in a proactive way.

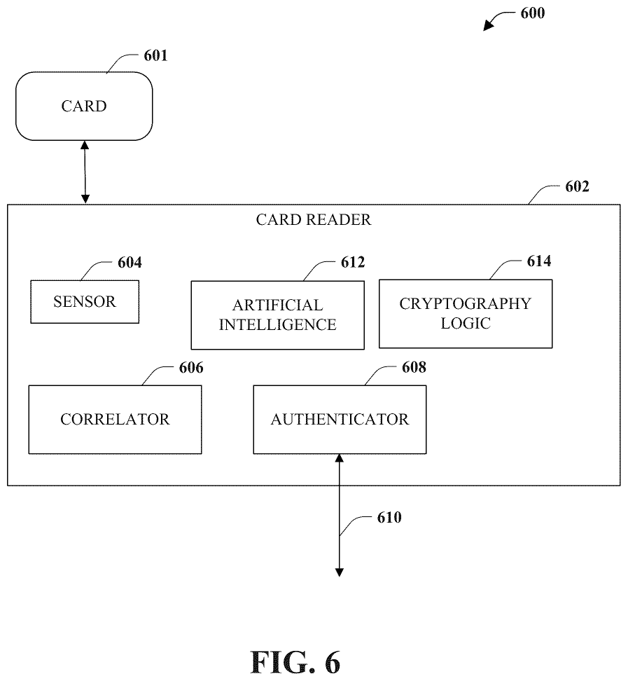

FIG. 6 illustrates another example system 600 for detecting a gait motion of a card 601. The example system 600 validates usage of the card 601 with a card reader 602. The example system 600 includes a sensor 604, a correlator 606, an authenticator 608, artificial intelligence 612, and cryptographic logic 614. In this example configuration, the correlator 606, the authenticator 608, the artificial intelligence 612, and the cryptographic logic 614 are illustrated as being part of the card reader 602 and can be implemented in hardware, silicon, or other materials. Alternatively, correlator 606, the authenticator 608, the artificial intelligence 612, and the cryptographic logic 614 can be computer-executable components specified in terms of instructions that cause a processor to perform the functionality of each component.

The card reader 602 can be a slot type of card reader, a swipe type of card reader, or another type of card reader. In general, the card reader 602 is a data input device that reads data from a card.

The sensor 604 detects motion-related data with respect to a card 601 moving with respect to the card reader 602. The sensor 604 can be an accelerometer that measures the acceleration with respect to a stationary card reader. The sensor can also be a 9-axis sensor, inertial motion sensor, a magnetometer, a gyroscope/gyrometer sensor, or another motion detection sensor. In some aspects, the sensor 604 captures movement data associated with the card's movement gait as the card 601 is moved with respect to the card reader 602. The movement gait of the card 601 can be relatively unique to the card owner in how the card owner moves the card 601 with respect to the card reader 602.

The correlator 606 correlates the card movement gait to a known gait data of the user. As, or after, card movement data (e.g., card movement gait) is collected, the correlator 606 compares this card movement data to different prior stored versions of pre-stored gait data that have been collected in the past for multiple card holders. The correlator 606 uses the results of these comparisons to determine if the card movement data potentially matches any of those earlier stored versions of pre-stored gait data and can assign a confidence level to that determination.

The authenticator 608 determines if the card movement data matches one of the prior stored versions of pre-stored gait data to an adequate level to conclude that prior card movement data matches one of pre-stored gait data. This can be based on the confidence level assigned by the correlator 606. This determination is output on line 610 so that this result can be transmitted to an entity that can allow the transaction or can block the transaction initiated at the card reader 602. When the gait of the card movement has been verified to be a card owner, the authenticator 608 can determine a true card owner has possession of the card. When the person swiping, inserting/removing, or moving the card at the card 601 at the card reader 602 is verified, the business transaction can be permitted to proceed at the time of the sale. If the person moving the card 501 at card reader 602 is not verified and is determined to be fraudulent, the business transaction can be blocked/terminated as a fraudulent transaction in a proactive way.

The correlator 606 and/or the authenticator 608 can be assisted by artificial intelligence 612 to correlate gait data and/or determine if gait data matches the user of the card 601. Artificial intelligence is the simulation of human intelligence processes by machines, especially computer systems. Specific applications of AI include expert systems, natural language processing, and speech recognition and machine vision. AI sometimes requires a foundation of specialized hardware and software for writing and training machine learning algorithms. In general, AI systems work by ingesting large amounts of labeled training data, analyzing the data for correlations and patterns, and using these patterns to make predictions about future states. In this way, a chatbot that is fed examples of text chats can learn to produce lifelike exchanges with people, or an image recognition tool can learn to identify and describe objects in images by reviewing millions of examples. AI programming focuses on three cognitive skills: learning, reasoning and self-correction. Learning processes. This aspect of AI programming focuses on acquiring data and creating rules for how to turn the data into actionable information. The rules, which are called algorithms, provide computing devices with step-by-step instructions for how to complete a specific task. The specific task of interest for the artificial intelligence 612 is to correlate gait data of a current card user to the gait data of other card users and determine if there is a match between the current gait data and other valid card user data and to prevent, or proactively block use of the card 601 when potential fraud is detected.

The cryptographic logic 614 is operable to encrypt and/or decrypt data using encryption and/or decryption algorithms or functions. The cryptographic logic 614 can receive, retrieve, or otherwise obtain the encrypted or decrypted data from the sensor 604, correlator 606, and/or authenticator and perform cipher operations on that data. The cryptographic logic 614 provides a way to transmit encrypted data from the card reader 602 and receive encrypted data into the card reader 602 that can then be decrypted. For example, the Advanced Encryption Standards (AES), Data Encryption Standard (DES), or another suitable encryption standard or algorithm can be used. In one instance, symmetric-key encryption can be employed in which a single key both encrypts and decrypts data. The key can be saved locally or otherwise made accessible by the cryptographic logic 614. Of course, asymmetric-key encryption can also be employed in which different keys are used to encrypt and decrypt data. For example, a public key for a destination downstream function can be utilized to encrypt the data. In this way, the data can be decrypted downstream at a user device, as mentioned earlier, utilizing a corresponding private key of a function to decrypt the data. Alternatively, a downstream function could use its public key to encrypt known data.

The example system 600 can provide an additional level of security to the encoded data by digitally signing the encrypted data. Digital signatures employ asymmetric cryptography. In many instances, digital signatures provide a layer of validation and security to messages (i.e., website data) sent through a non-secure channel. Properly implemented, a digital signature gives the receiver, user device, reason to believe the message was sent by the claimed sender.

Digital signature schemes, in the sense used here, are cryptographically based, and must be implemented properly to be effective. Digital signatures can also provide non-repudiation, meaning that the signer cannot successfully claim they did not sign a message, while also claiming their private key remains secret. In one aspect, some non-repudiation schemes offer a timestamp for the digital signature, so that even if the private key is exposed, the signature is valid.

Digitally signed messages can be anything representable as a bit-string such as encrypted website data. The cryptographic logic 614 can use signature algorithms such as RSA (Rivest-Shamir-Adleman), which is a public-key cryptosystem that is widely used for secure data transmission. Alternatively, the Digital Signature Algorithm (DSA), a Federal Information Processing Standard for digital signatures, based on the mathematical concept of modular exponentiation and the discrete logarithm problem can be used. Other instances of the V can use other suitable signature algorithms and functions. When the encoding and encryption of the data are completed or when enough data has been encoded and encrypted, a transmitter can begin transmitting the encoded data to another external device. For example, in a business or banking transaction, the transaction data can be safely transmitted to a remote external enterprise server.

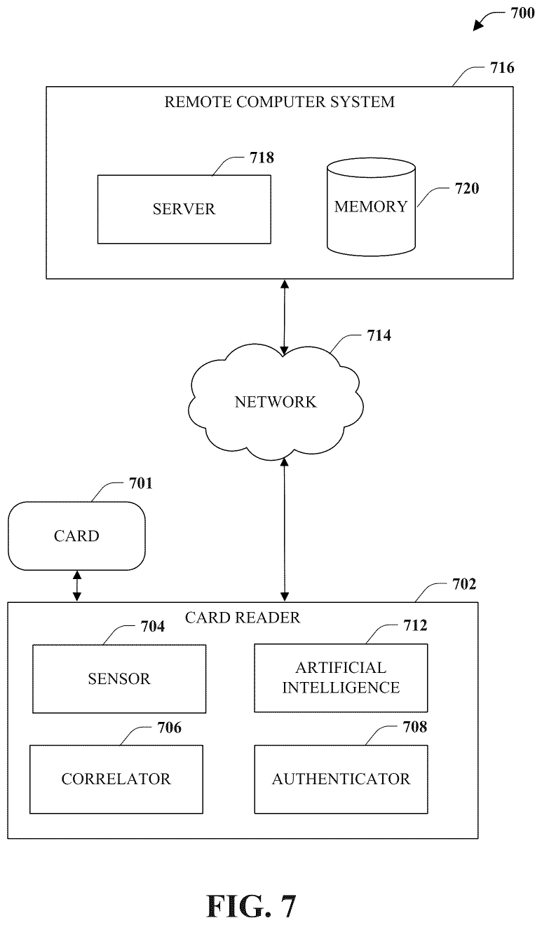

FIG. 7, illustrates an example computer system 700 with an enterprise computer system 716, a network, 714, and a card reader 702. The enterprise computer system 716 and the card reader 702 are both connected to the network 714. The enterprise computer system 716 can be a business computer system managing and/or interacting with remote business computers such as banking computers or remote banking terminals, or other related devices. The enterprise computer system 716 interfaces with user devices such as the card reader 702. The card reader 702 can be part of a device operated by an individual user, such as a laptop, a phone, a tablet, and the like.

The enterprise computer system 716 can include a server 718 and a memory system 720. The server 718 is generally a piece of computer hardware and/or software that provides functionality to other software programs and/or devices such as client devices. The server 718 can be a virtual machine that is performing server services. A hypervisor can be used to direct a physical computer to function at least partially as a virtual server.

The memory system 720 can be any suitable device capable of storing and permitting the retrieval of data. In one aspect, the memory system 720 is capable of storing notifications or messages or related data. The memory system 720 can include storage media that includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices. The memory system 720 can be any suitable device capable of storing and permitting the retrieval of data.

The enterprise computer system 716 can be connected to the card reader 702 through a network 714. The network 714 can include portions of a local area network such as an Ethernet, portions of a wide area network such as the Internet, and can be a wired, optical, or wireless network. The network 714 can include other components and software as understood by those of ordinary skill in the art.

The sensor 704 detects motion-related data with respect to a card 701 moving with respect to the card reader 702. The sensor 704 can be an accelerometer that measures the acceleration with respect to a stationary card reader. In some aspects, the sensor 704 captures movement data associated with the card's movement gait as the card 701 is moved with respect to the card reader 702. The movement gait of the card 701 can be relatively unique to the card owner in how the card owner moves the card 701 with respect to the card reader 702.

The correlator 706 correlates the card movement gait to a known gait data of the user. As, or after, card movement data (e.g., card movement gait) is collected, the correlator 706 compares this card movement data to different prior stored versions of pre-stored gait data that have been collected in the past for multiple card holders. The correlator 706 uses the results of these comparisons to determine if the card movement data matches any of those earlier stored versions of pre-stored gait data.

The correlator 706 can compare the card movement data to different samples of pre-stored gait data in any way as understood by those of ordinary skill in the art. For example, the correlator 706 can perform a Fourier transformation to convert the card movement data to the frequency domain because it can be much easier to make frequency domain comparisons between the card movement data and the pre-stored gait data. Alternatively, the correlator 706 can graphically compare the card movement data to the pre-stored gait data.

The authenticator 708 determines if the card movement data matches one of the prior stored versions of pre-stored gait data to an adequate threshold level to conclude that prior card movement data matches one of pre-stored gait data. In other words, the person swiping, inserting, and/or moving the card 701 at the card reader 702 is an owner of the card because their swipe, insertion/removal gait, or other card movement at the card reader matches the gait of a known owner of the card. When the gait of the card movement has been verified to be a card owner, the authenticator 708 can determine a true card owner has possession of the card. When the person swiping or inserting/removing the card 701 from a card reader is verified, authenticator 708 can allow the business transaction can be permitted to proceed at the time of the sale in a proactive way. If the person swiping or inserting/removing the card from a card reader is not verified and is determined to be fraudulent, the authenticator 708 can block/terminate the business transaction as a fraudulent transaction.

The correlator 706 and/or the authenticator 708 can be assisted by artificial intelligence 712 to correlate gait data and/or determine if gait data matches the user of the card 701. Artificial intelligence is the simulation of human intelligence processes by machines, especially computer systems. The specific task of interest for the artificial intelligence 712 is to correlate gait data of a current card user to the gait data of other card users and determine if there is a match between the current gait data and other valid card user data and to prevent, or proactively block use of the card 701 when potential fraud may be detected.

In one example operation, the card reader 702 reads account information from a card 701 issued to a user. The card reader 702 will read this information by using one or more sensors 704 with the capability of reading magnetic data, memory cell data, or other data. This sensor data is then processed within the card reader 702. As discussed above, the correlator 706 will correlate the card movement gait to a known gait data of the user by using Fourier transformation frequency domain data or in another way. The authenticator 708 uses the correlation results to authenticate the user before the business transactions occur with respect to the card 701 to prevent fraud before fraud occurs with respect to the transaction. The authenticator 708 allows a business transaction associated with the card 701 to proceed when the card movement gait is authenticated with the known gait data. The authentication results can be transmitted through the network 714 to the enterprise computer system 716.

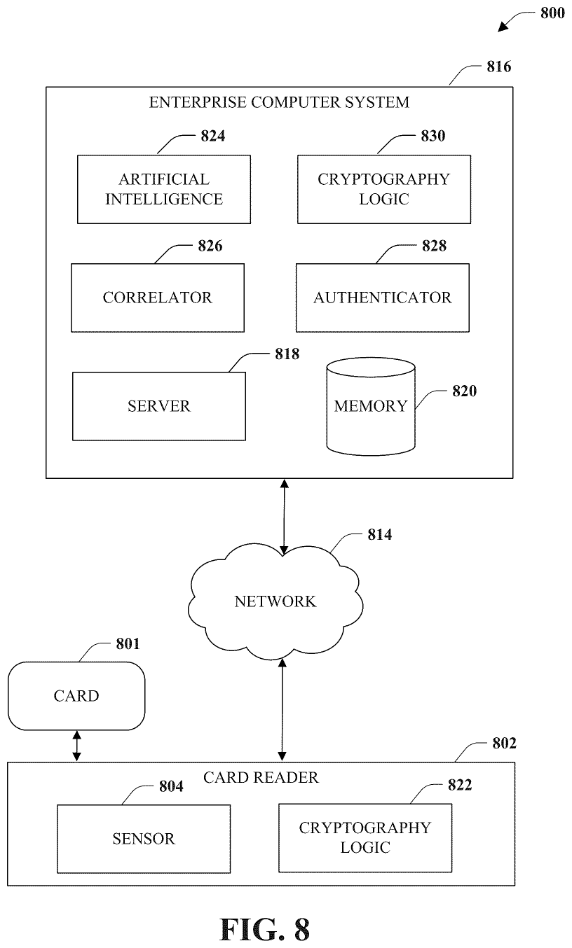

FIG. 8, illustrates an example computer system 800 with an enterprise computer system 816, a network, 814, and a card reader 802. The enterprise computer system 816 and the card reader 802 are both connected to the network 814. The enterprise computer system 816 can be a business computer system managing and/or interacting with remote business computers such as banking computers or remote banking terminals or other related devices. The enterprise computer system 816 interfaces with user devices such as the card reader 802. The card reader 802 can be a device operated by an individual user at a laptop, a phone, a tablet, and the like.

The enterprise computer system 816 can be connected to the card reader 802 through a network 814. The network 814 can include portions of a local area network such as an Ethernet, portions of a wide area network such as the Internet, and can be a wired, optical, or wireless network.

The sensor 804 detects motion-related data with respect to a card 801 moving with respect to the card reader 802. The sensor 804 can be an accelerometer that measures the acceleration with respect to a stationary card reader. In some aspects, the sensor 804 captures movement data associated with the card's movement gait as the card 801 is moved with respect to the card reader 802. The movement gait of the card 801 can be relatively unique to the card owner in how the card owner moves the card 801 with respect to the card reader 802.

The cryptographic logics 822 and 830 are operable to encrypt and/or decrypt data using encryption and/or decryption algorithms or functions. The cryptographic logics 822 and 830 can receive, retrieve, or otherwise obtain the encrypted or decrypted data from the sensor 804, correlator 826, and/or authenticator 828 and perform cipher operations on that data. The cryptographic logic 822 provides a way to transmit encrypted data from the card reader 802 and receive encrypted data into the card reader 802 that can then be decrypted. For example, the Advanced Encryption Standards (AES), Data Encryption Standard (DES), or another suitable encryption standard or algorithm can be used. In one instance, symmetric-key encryption can be employed in which a single key both encrypts and decrypts data.

The enterprise computer system 816 can include a server 818, a correlator 826, an authenticator 828, artificial intelligence 824, cryptographic logic 830, and a memory system 820. The server 818 is generally a piece of computer hardware and/or software that provides functionality to other software programs and/or devices such as client devices. The memory system 820 can be any suitable device capable of storing and permitting the retrieval of data. In one aspect, the memory system 820 is capable of storing notifications or messages or related data.

The correlator 826 is to correlate the card movement gait to a known gait data of the user. The correlator 826 compares this card movement data to different prior stored versions of pre-stored gait data that have been collected in the past for multiple card holders.

The authenticator 828 determines if the card movement data matches one of the prior stored versions of pre-stored gait data to an adequate level to conclude that prior card movement data matches one of pre-stored gait data. In other words, the person swiping or inserting the card 801 across or into and out of the card reader 802 is an owner of the card 801 because their swipe or insertion/removal gait matches the gait of a known owner of the card 801. When the gait of the card movement has been verified to be a card owner, the authenticator 828 can determine a true card owner has possession of the card and that a function based on the card 801 may be performed

The correlator 826 and/or the authenticator 828 can be assisted by artificial intelligence 824 to correlate gait data and/or determine if gait data matches the user of the card 801. Artificial intelligence is the simulation of human intelligence processes by machines, especially computer systems. The specific task of interest for the artificial intelligence 824 is to correlate gait data of a current card user to the gait data of other card users and determine if there is a match between the current gait data and other valid card user data and to prevent, or proactively block use of the card 801 when potential fraud may be detected.

In operation, the card reader 802 is to read account information from a card 801 issued to a user. The card reader 802 will read this information by using one or more sensors 804 with the capability of reading magnetic data, memory cell data, or other data. The sensor data can be encrypted by the cryptographic logic 822 and sent through the network 814 to the enterprise computer system 816. The encrypted data is decrypted by the cryptographic logic 830 in the enterprise computer system 816. The sensor data is then processed within the enterprise computer system 816. As discussed above, the correlator 826 will correlate the card movement gait to a known gait data of the user by using Fourier transformation frequency domain data or in another way. The authenticator 828 authenticates the card movement gait with the known gait data to authenticate the user. The authenticator 828 authenticates the card movement gait with the known gait data to authenticate the user before the business transactions occur with respect to the card 801 to prevent fraud before fraud occurs with respect to the business transaction. The authenticator 828 allows a business transaction associated with the card 801 to proceed when the card movement gait is authenticated with the known gait data. The authentication results can be transmitted through the network 814 to the enterprise computer system 816.

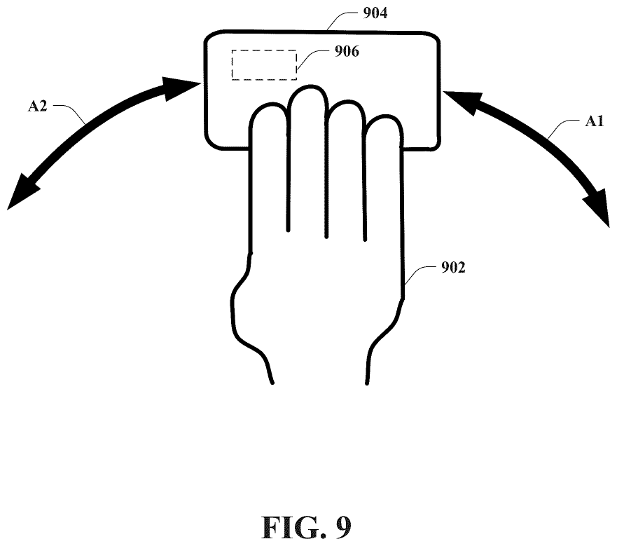

FIG. 9 illustrates an example waving movement of a card 904 with a movement sensor 906 built into the card 904. An owner of the card 904 can hold the card 904 with their hand 902 and swing the card 904 in a partial circular motion in the directions of arrows A1 and A2. The owner can make this movement of the card 904 one or more times. Alternatively, the owner can move the card 904 in a figure “8” type of movement to activate a function based on the card 904. The function can be a banking function, opening a lock controlling a door for access into a space, or another function or activity. The card 904 can also be tapped on something one or more times to activate a function. In other situations, a shaking motion of the card 904 can be detected. As each of these motions are performed, the movement sensor 906 can transmit data associated with the particular movement to a nearby device. The nearby device can be a card reader and the sensor can be in a card reader.

The card 904 can have other useful features and functions. In some instances, the card 904 can contain a heat sensor(s) to detect when someone is holding the card 904. Other sensors can detect how tightly the card 904 is being held. In some situations, the card can be used for a joint account, and signatures of different users of the card 904 can be learned. Members jointly using the card 904 can have different credit limits when using the same card. The card 904 can include other sensors, such as a biometric sensor for capturing a fingerprint or eye scan. A camera within the card 904 can be useful for taking a picture when the card is being used. In some situations, other sensor data can be used in addition to the movement sensor data. In other situations, sensor data from multiple sensors can be used when one situation is more critical than another situation. For example, when buying a cup of coffee, only the movement sensor 906 can be used, but when buying a $1000 TV other sensors can be used in addition to the movement sensor 906 to authenticate the transaction for the TV. Location, amount, and past transaction history can all be fed into an algorithm to determine which sensors are used to verify an owner of the card is using the card 904. In one particular situation, if a card is used to pay for a meal and then is trying to be used again a short time later, the second user can be authenticated because an employee may be trying, without authority, to copy information from the card.

The aforementioned systems, architectures, platforms, environments, or the like have been described with respect to interaction between several logics and components. It should be appreciated that such systems and components can include those logics and/or components or sub-components and/or sub-logics specified therein, some of the specified components or logics or sub-components or sub-logics, and/or additional components or logics. Sub-components could also be implemented as components or logics communicatively coupled to other components or logics rather than included within parent components. Further yet, one or more components or logics and/or sub-components or sub-logics can be combined into a single component or logic to provide aggregate functionality. Communication between systems, components or logics and/or sub-components or sub-logics can be accomplished following either a push and/or pull control model. The components or logics can also interact with one or more other components not specifically described herein for the sake of brevity but known by those of skill in the art.

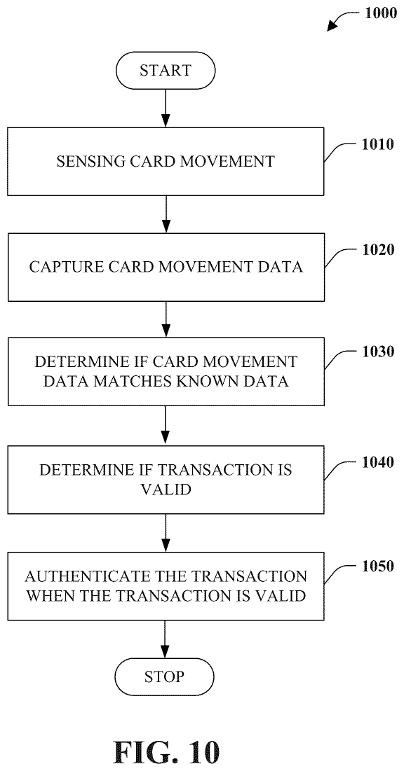

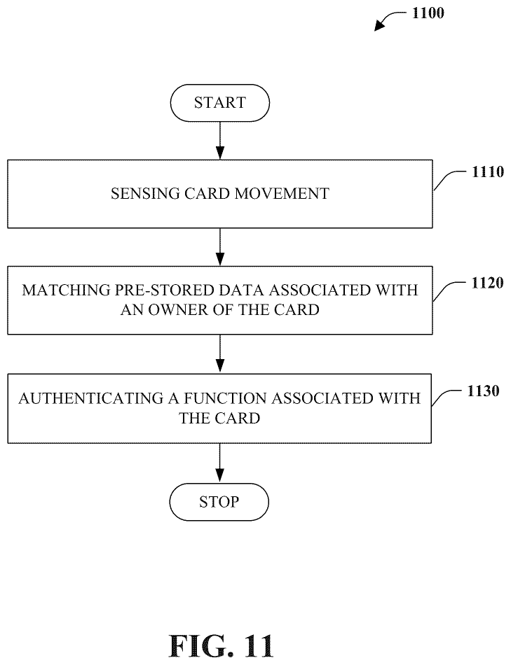

In view of the example systems described above, methods that can be implemented in accordance with the disclosed subject matter will be better appreciated with reference to flow chart diagrams of FIGS. 10 and 11. While for purposes of simplicity of explanation, the methods are shown and described as a series of blocks, it is to be understood and appreciated that the disclosed subject matter is not limited by the order of the blocks, as some blocks can occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 10, a method 1000 for verifying authorized use of a card is depicted in accordance with an aspect of this disclosure. The method 1000 for verifying authorized use of a card can be performed by the example system 200 for card use, as discussed above with reference to FIG. 2.

At reference numeral 1010, sensing card movement is performed. The card movement data can be associated with a speed of a card moving within a proximity of a card reader device. Card movement data associated with the card movement is captured at reference numeral 1020. In some instances, the card movement data can be sensed using a sensor in the card. The sensor can be an accelerometer, a 10-axis sensor, or another motion detection sensor. In some applications, sensing movement data is associated with a back and forth waving motion of the card while the card is held by the owner of the card.

At reference number 1030, a determination is made as to whether the card movement data matches pre-stored data associated with an owner of the card. In some situations, the card movement data is matched to pre-stored graphs of data. Some situations may correlate using Fourier transforms of the card movement data whether the card movement data matches pre-stored data associated with an owner of the card. Thus, the matching may be performed in the frequency domain.

At reference number 1040, a determination is made as to whether a transaction is valid based on whether the card movement data matches the pre-stored data associated with an owner of the card. Confidence factors can be used when determining how well card movement data matches pre-stored data, and these confidence factors can be used when determining if the transaction is valid. In some embodiments, a machine learning model can be used to determine if the transaction is valid.

At reference number 1050, authenticating the transaction when the transaction is valid. Determining whether the transaction is valid based on whether the card movement data matches pre-stored data before the transaction occurs to prevent fraud before the fraud occurs. The authenticating the transaction can be performed at the edge of the Internet of Things (IoT).

In another situation, the method 1000 determines whether the card is physically touching the card reader device. The determining whether the transaction is valid can be based on whether the card is physically touching the card reader device. The detecting if the card is physically present at the card reader can be made by using a sensor. A card present transaction flag is set when the card is physically present at the card reader. The determining whether the transaction is valid can be based on whether the card present transaction flag is set.

FIG. 11 depicts a method 1100 for verifying authorized use of a card. The method 1100 can be implemented and performed by the example system 200, illustrated in FIG. 2, for verifying authorized use of a card.

The method 1100 executes on an electronic device processor. Instructions are executed that cause the electronic device processor to perform operations for detecting fraudulent use of a card before the fraud occurs. The operations include, at numeral 1110, sensing card movement associated with a speed of a card moving within a proximity of a card reader device. In some instances, the sensing of the card movement data uses a sensor in the card. The sensor can be an accelerometer, a 9-axis sensor, an inertial gyrometer sensor, a magnetometer sensor, or another sensor.

The method 1100, at reference numeral 1120, determines whether the card movement data matches pre-stored data associated with an owner of the card. In some configurations, the method can determine whether the card movement data matches the pre-stored data using a machine learning model. The card movement data matches the pre-stored data using edge computing on an internet-of-things (IoT).

At reference numeral 1130, a function associated with the card is authenticated when the card movement data matches the pre-stored data associated with an owner of the card above a confidence threshold level. When the person swiping or inserting/removing the card from a card reader is verified, a business transaction (e.g., a function) or another function controlled by the card, such as unlocking a door, can be permitted to proceed.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component can be but is not limited to being a process running on a processor, a processor, an object, an instance, an executable, a thread of execution, a program, and/or a computer. By way of illustration, both an application running on a computer and the computer can be a component. One or more components can reside within a process and/or thread of execution, and a component can be localized on one computer and/or distributed between two or more computers.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

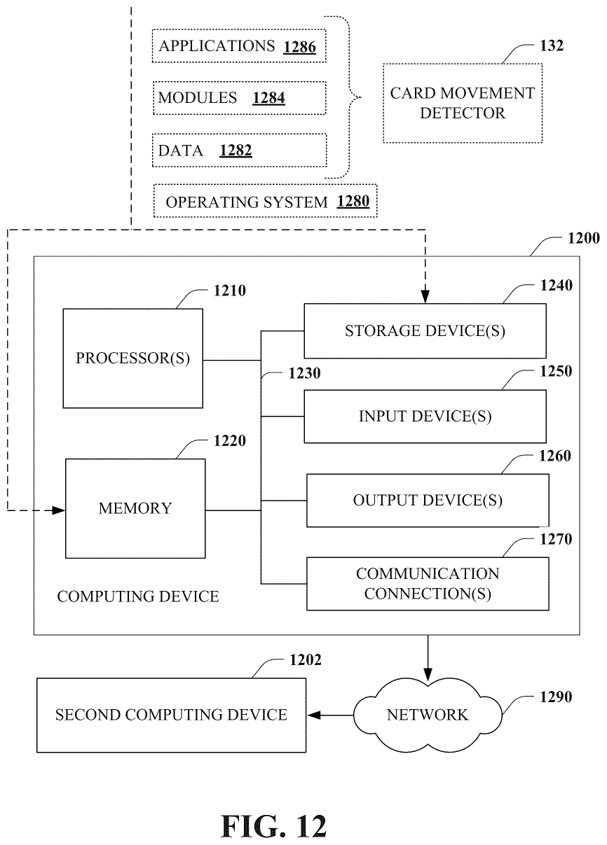

To provide a context for the disclosed subject matter, FIG. 12, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules can be located in one or both of local and remote memory devices.

With reference to FIG. 12, illustrated is an example computing device 1200 (e.g., desktop, laptop, tablet, watch, server, hand-held, programmable consumer or industrial electronics, set-top box, game system, compute node). The example computing device 1200 includes one or more processor(s) 1210, memory 1220, system bus 1230, storage device(s) 1240, input device(s) 1250, output device(s) 1260, and communications connection(s) 1270. The system bus 1230 communicatively couples at least the above system constituents. However, the example computing device 1200, in its simplest form, can include one or more processor(s) 1210 coupled to memory 1220, wherein the processor(s) 1210 execute various computer-executable actions, instructions, and or components stored in the memory 1220.

The processor(s) 1210 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. The processor(s) 1210 can also be implemented as a combination of computing devices, for example, a combination of a DSP and a microprocessor, a plurality of microprocessors, multi-core processors, one or more microprocessors in conjunction with a DSP core, or any other such configuration. In one configuration, the processor(s) 1210 can be a graphics processor unit (GPU) that performs calculations concerning digital image processing and computer graphics.

The example computing device 1200 can include or otherwise interact with a variety of computer-readable media to facilitate control of the computing device to implement one or more aspects of the disclosed subject matter. The computer-readable media can be any available media accessible to the example computing device 1200 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the example computing device 1200. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 1220 and storage device(s) 1240 are examples of computer-readable storage media. Depending on the configuration and type of computing device, the memory 1220 can be volatile (e.g., random access memory (RAM)), non-volatile (e.g., read only memory (ROM), flash memory . . . ), or some combination of the two. By way of example, the basic input/output system (BIOS), including basic routines to transfer information between elements within the example computing device 1200, such as during start-up, can be stored in non-volatile memory, while volatile memory can act as external cache memory to facilitate processing by the processor(s) 1210, among other things.

The storage device(s) 1240 include removable/non-removable, volatile/non-volatile storage media for storage of vast amounts of data relative to the memory 1220. For example, storage device(s) 1240 include, but are not limited to, one or more devices such as a magnetic or optical disk drive, floppy disk drive, flash memory, solid-state drive, or memory stick.

Memory 1220 and storage device(s) 1240 can include, or have stored therein, operating system 1280, one or more applications 1286, one or more program modules 1284, and data 1282. The operating system 1280 acts to control and allocate resources of the example computing device 1200. Applications 1286 include one or both of system and application software and can exploit management of resources by the operating system 1280 through program modules 1284 and data 1282 stored in the memory 1220 and/or storage device(s) 1240 to perform one or more actions. Accordingly, applications 1286 can turn a general-purpose computer into a specialized machine in accordance with the logic provided thereby.

All or portions of the disclosed subject matter can be implemented using standard programming and/or engineering techniques to produce software, firmware, hardware, or any combination thereof to control the example computing device 1200 to realize the disclosed functionality. By way of example and not limitation, all or portions of the card movement detector 132 can be, or form part of, the application 1286, and include one or more program modules 1284 and data 1282 stored in memory and/or storage device(s) 1240 whose functionality can be realized when executed by the processor(s) 1210.

In accordance with one particular configuration, the processor(s) 1210 can correspond to a system on a chip (SOC) or like architecture including, or in other words integrating, both hardware and software on a single integrated circuit substrate. Here, the processor(s) 1210 can include one or more processors as well as memory at least similar to the processor(s) 1210 and memory 1220, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the card movement detector 132 and/or functionality associated therewith can be embedded within hardware in a SOC architecture.

The input device(s) 1250 and output device(s) 1260 can be communicatively coupled to the example computing device 1200. By way of example, the input device(s) 1250 can include a pointing device (e.g., mouse, trackball, stylus, pen, touchpad), keyboard, joystick, microphone, voice user interface system, camera, motion sensor, and a global positioning satellite (GPS) receiver and transmitter, among other things. The output device(s) 1260, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 1250 and output device(s) 1260 can be connected to the example computing device 1200 by way of wired connection (e.g., bus), wireless connection (e.g., Wi-Fi, Bluetooth), or a combination thereof.

The example computing device 1200 can also include communication connection(s) 1270 to enable communication with at least a second computing device 1202 utilizing a network 1290. The communication connection(s) 1270 can include wired or wireless communication mechanisms to support network communication. The network 1290 can correspond to a local area network (LAN) or a wide area network (WAN) such as the Internet. The second computing device 1202 can be another processor-based device with which the example computing device 1200 can interact.

In one instance, the example computing device 1200 can execute a card movement detector 132 for a first function, and the second computing device 1202 can execute a card movement detector 132 for a second function in a distributed processing environment. Further, the second computing device can provide a network-accessible service that stores source code, and encryption keys, among other things that can be employed by the card movement detector 132 executing on the example computing device 1200.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
sensing card movement associated with a motion of a card moving within a proximity of a card reader device, wherein the card is employed in a financial transaction;
capturing, from a sensor, card movement data associated with the card movement;
comparing the captured card movement data to pre-stored data associated with an owner of the card to create a comparison result; and
authenticating a user of the card as the owner of the card when the comparison result satisfies a predetermined threshold.

2. The method of claim 1, further comprising:
sensing whether the card is physically touching the card reader device; and
factoring a physical contact of the card to the card reader device into the authenticating.

3. The method of claim 1, further comprising determining, using a Fourier transform, whether the card movement data matches pre-stored data associated with the owner of the card.

4. The method of claim 1, further comprising sensing the card movement data using a sensor embedded within the card.

5. The method of claim 1, further comprising sensing the card movement data using an accelerometer sensor embedded within the card.

6. The method of claim 1, further comprising:
detecting physical presence of the card at the card reader device;
setting a card present flag in the card movement data that represents the physical presence of the card at the card reader device; and
factoring the card present flag into the authenticating.

7. The method of claim 1, further comprising capturing a back and forth waving motion of the card.

8. The method of claim 1, further comprising determining whether the card movement data matches the pre-stored data with a machine learning model.

9. The method of claim 1, further comprising determining whether the card movement data matches the pre-stored data with edge computing on an internet-of-things (IoT) device.

10. The method of claim 1, further comprising sensing the card movement data using a 9-axis sensor embedded within the card.

11. The method of claim 1, further comprising altering the predetermined threshold for the comparison result in response to a type, amount, or timing of the financial transaction.

12. A system comprising:
a card reader that captures financial account information from a card issued to a user;
a sensor that captures movement data associated with a card movement gait of the card in relation to the card reader;
a correlator that compares the card movement gait to a known card gait data unique to the user to create a comparison result; and
an authenticator that validates the user based on the comparison result of the card movement gait with the known card gait data, wherein validation of the user allows a financial transaction associated with the card to proceed.

13. The system of claim 12, further comprising a detection sensor that establishes that the card is physically touching the card reader and wherein the authenticator validates user identity in response to physical contact with the card reader.

14. The system of claim 12, wherein the authenticator compares the comparison result to a predetermined threshold related to an amount of the financial transaction and validates the user when the comparison result satisfies the predetermined threshold.

15. The system of claim 12, further comprising a machine learning (ML) model to determine whether the card movement gait matches the known card gait data.

16. The system of claim 12, wherein the correlator determines whether the movement data matches the known card gait data with edge computing on an internet-of-things (IoT) device.

17. A method, comprising:
executing, on an electronic device processor, instructions that cause the electronic device processor to perform operations associated with authentication, the operations comprising:
sensing card movement associated with a physical presentation of a card moving within a proximity of a card reader device;
capturing card movement data that represents the card movement;
comparing the card movement data to pre-stored card movement data associated with a card owner to create a comparison result; and
authenticating the card owner based on the comparison result and a predetermined threshold, wherein the predetermined threshold is based on a type, amount, or timing of a financial transaction.

18. The method of claim 17, wherein the operations further comprise determining whether the card movement data matches the pre-stored card movement data with a machine learning model.

19. The method of claim 17, wherein the operations further comprise determining whether the card movement data matches the pre-stored card movement data with edge computing on an internet-of-things (IoT) device.

20. The method of claim 17, further comprising sensing the card movement data using a sensor embedded within the card, wherein the sensor is an accelerometer, a 9-axis sensor, an inertial gyrometer sensor, and/or a magnetometer sensor.
